(19) United States
(12) Patent Application Publication
(10) Pub. No.: US 2008/0282090 A1
(43) Pub. Date: Nov. 13, 2008

(54) Virtual Property System for Globally-Significant Objects

(76) Inventor: Jonathan Leybovich, Vancouver, WA (US)

Correspondence Address: FOOTHILL LAW GROUP, 777 N. FIRST STREET, SUITE 325, SAN JOSE, CA, 95112, US

(21) Appl. No.: 11/745,227

(22) Filed: May 7, 2007

(51) Int. Cl. H04K 1/00

(52) U.S. Cl. 713/182

(57) ABSTRACT

Virtual property system for globally-significant objects across autonomous computing environments. Objects with global persistence and identity are instantiated by a plurality of their real-world claim-holders through authentication of a computer-readable object specification and owner identity. Owner may then claim benefit of the object across autonomous computing environments such as virtual worlds by authenticating his identity. Ownership transfer is accomplished through the current owner authenticating an ownership transfer document. When used in conjunction with the owner-proxy method, object transfer may occur without the distribution of ownership revocation lists.

### FIELD

The invention relates to virtual property and more specifically to a method and system of virtual property ownership implemented across autonomous computing environments.

### BACKGROUND OF THE INVENTION

For several classes of property, a significant or even whole portion of an item's value consists in that item's identity rather than its material or functional characteristics. A general term for such classes of property is collectibles, and includes such property as original artwork, first-run print material, antiques, and celebrity and sports memorabilia. Often the item's value is a function of its association with a historically, culturally, or otherwise socially significant phenomenon, and invariably this value is enhanced by the item's rarity or uniqueness.

These particular characteristics make collectibles inherently amenable to virtualization, as the value of such items lies primarily in what they ARE as opposed to what they DO. Barry Bond's 715^{th} homerun ball, for example, is physically indistinguishable from any other professional-grade baseball, yet is immensely more valuable because of its culturally and historically significant identity. Indeed the physical embodiment of any collectible is mainly useful insofar as it limits the availability of that item, preserving its relative scarcity even as it is presented (“shown”) or transferred between owners. Assuming such scarcity constraints can be maintained on simulated—i.e. “virtual”—objects as well, there is no reason why such virtual objects cannot provide their owners with the chief satisfactions of all collectibles—these being the prestige derived from owning the remnants of desirable, culturally-significant, or even notorious phenomena, and the satisfaction of discovering, acquiring, and gathering together scarce, thematically-related objects (e.g. classic American sports cars, flight-related postage stamps) into well-ordered collections. If the collectible never had a physical embodiment (having, for example, existed only in fiction), had its physical embodiment lost or destroyed, or is even wholly conceptual in nature, then a virtual property system offers the sole means for achieving these satisfactions.

The basic viability and desirability of virtual property is proven by the existence of several primary and secondary online markets for the real-money exchange of virtual objects from persistent-state, multiplayer online games (also called massively multiplayer online games—MMOGS). Primary examples of such markets include the Sony Online Entertainment-run Station Exchange for its online fantasy role-playing game “Everquest”, and those operated within Linden Lab's “Second Life” virtual world environment. The novelty of virtual collectibles is therefore not the chief impediment to their adoption or to the general ascription of value and utility to them. The challenge of virtual property lies rather in imposing real-world scarcity constraints on what is essentially information and hence easily replicable. Cryptographic authentication mechanisms, particularly digital signature, provide a solution to some of the basic problems of virtual property yet no system currently addresses the specific requirements of collectibles or what are defined here with more generality as globally-significant objects. The principle characteristics of globally-significant objects are the global scope of their identity, persistence, and utility, meaning that none of these characteristics are limited to a particular context or operating environment. Using a computer systems example by way of analogy: an IP address from a private Internet address range (e.g. 192.168.*.*) is not globally-significant; an IP address from a public Internet address range is.

Current virtual property systems use centralized or at least coordinated systems of property creation, authentication, and transfer, where each virtual object is controlled within a particular object registry which is accessed whenever basic property functions are performed. This is problematic for globally-significant objects, as receiving systems must either maintain up-to-date lists of extant object registries, or else refuse some objects, diminishing their portability and hence their utility. Of particular concern is the authentication of ownership, which in some property systems requires access to up-to-date ownership registry lists to ensure that once valid ownership claims have not subsequently expired through such actions as the transfer of the object to a new owner.

### BRIEF SUMMARY OF THE INVENTION

The present invention specifies a virtual property system for globally-significant objects, defined in this application as objects with identity, persistence, and utility not confined to any particular context or operating environment. In the context of on-line games, for example, a globally-significant virtual object would have potential value across a plurality of games. A typical, though not limiting, example of a globally-significant object is a collectible. Because globally-significant objects often are extant in the real world prior to their existence as virtual objects, a method of instantiation is one aspect of this invention. Instantiation, as used in this application, is the process of imparting to a virtual object the identity of a “real world” object, even when there is a “real-world” manifestation of the object that is separate from, and possibly owned independently of, the virtual representation.

The other aspect of the invention is an ownership system requiring minimal coordination between the systems which receive the virtual objects, the systems which instantiate them, and the systems that register their ownership profiles. This is done through an owner-proxy system of property management where objects are assigned to entities that act as trusted 3^{rd-}party arbitrators of their ownership status, authenticating duration-limited object claim certificates identifying a particular party as the object's actual owner until such time as the object is transferred, at which point the owner-proxy switches to authenticating the new actual owner. The owner-proxy thus ensures that no two authenticated ownership claims are ever in effect at the same time for different owners.

With the preferred embodiment's public key infrastructure method of authentication, systems receiving a virtual object need never interact with either the systems which instantiate objects, nor the systems which act as owner-proxies. The identity and ownership characteristics of the object are both determined “in-line” using an object ownership certificate and chain of object transfer/claim documents presented by the user. Object identity is determined using a combination of data from a virtual object specification and the identities of the claim-holders who authenticated the object at the time of instantiation. Claim-holder, as used in this invention, is an entity, either individual or corporate, with substantial socially-recognized right towards determining the disposition of an object. Such a right may consist in either ownership or physical possession of the object, artistic or intellectual contributions towards its realization, or administrative control as to its employment and development. For example, authentication of an object by “Major League Baseball” classifies it as a type of professional baseball memorabilia; various identifiers in the object specification, including unique keys such as serial numbers, determine which piece of memorabilia it is. Authentication of the ownership status of the user who presents the object is similarly done “in-line” by cryptographically validating the chain of ownership transfer/claim documents presented, then presenting an identity challenge for the current owner as defined by the chain. In neither case is an external system contacted, allowing the object to be presented in a maximality of environments and hence preserving its global portability.

### BRIEF DESCRIPTION OF THE DRAWINGS

These and other features, aspects and advantages of the present invention will become better understood with regard to the following description, appended claims and accompanying drawings, where:

FIG. 1 is a schematic diagram of an object specification document.

FIG. 2 is a flow diagram for the object instantiation method

FIG. 3 is a flow diagram depicting the object transfer

FIG. 4 is a flow diagram depicting object presentation to a system wherein the object is to be used

FIG. 5 is a flow diagram for the owner-proxy method

### DETAILED DESCRIPTION OF THE INVENTION

There are two aspects to the invention: a method of virtual object instantiation and an owner-proxy method of virtual object ownership.

### Instantiation Method

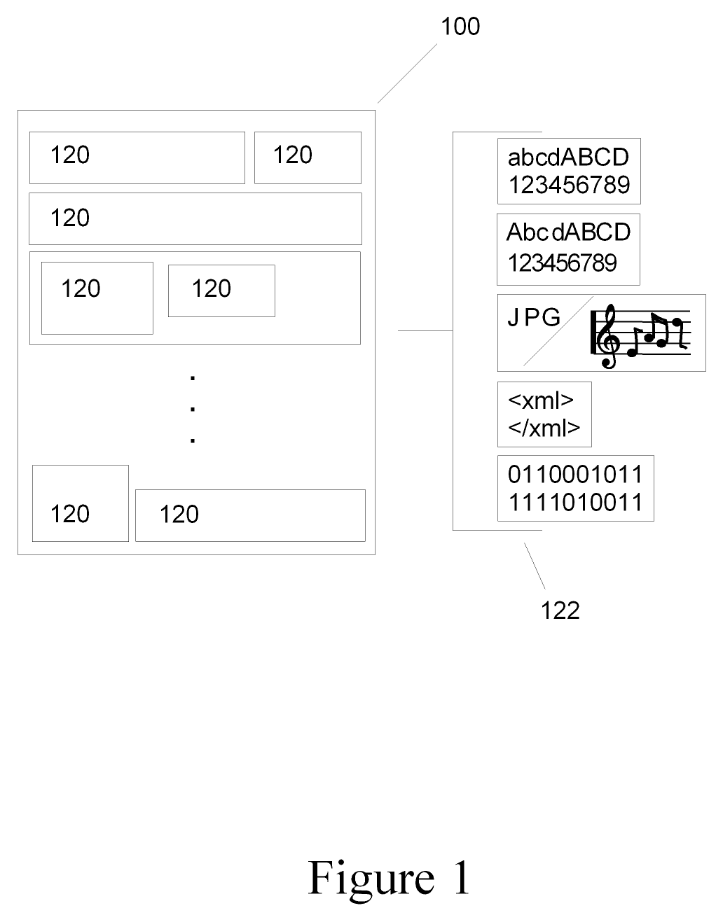

Instantiation of a globally-significant virtual object begins with the creation of a computer-readable virtual object specification, illustrated in FIG. 1. An object specification 100 is comprised of one or more of fields 120, each containing data of a particular type 122. Possible data types include text (possibly repeated for one or more translations into alternate major languages); multimedia content such as graphics, sound, or video; structured data (e.g. XML); or digital (e.g. binary) data. Other data types are possible as well. Fields may be nested within other fields, of same or different type, to an arbitrary depth. For example, a XML document field could contain within it (“envelope”) both structured XML sub-documents, free-form text, and encoded binary data. FIG. 1 is a conceptual illustration and does not define a particular encoding or structure for the object specification. In fact, the invention disclosed here can function with a plurality of different object specification formats or encodings.

The object specification should be as descriptive as possible, and meaningful to a human examining it without recourse to any external system except a computer used to render or visualize the specification's data. In particular, the specification must unambiguously identify the object that it embodies. Thus an object specification will typically consist of natural language text, preferably repeated for a plurality of major world languages. Though the specification may contain controlled values optimized for efficient automated lookup (such as alphanumeric keys, codes, or serial numbers) these should not be used as substitutes for actual data residing only within some external system: the object embodied in the specification has indefinite persistence, and so must not become unusable through dependence on external systems that may cease operation.

The object specification may, however, contain various computer-optimized data. In addition to unique keys or serial numbers identifying the overall object, it may contain structured data describing the characteristics of the object comprised mainly of numeric and/or enumerated values taken from a controlled vocabulary. Those skilled in the art will recognize those object modeling techniques that are applicable here. In particular, the use of standard interfaces for broad classes of objects (e.g. vehicles, buildings, works of art, etc.) will allow systems to accept every object within a particular class using only a single set of rules.

Though the specification should be as descriptive as possible, in practice it is not possible to account for every attribute that may prove significant to users of the object. Attributes which may be objectively and unambiguously determined from the identity of the object (e.g. the physical measurements of a physically-embodied object) are thus less important to consider when creating the specification than attributes that are conceptual or subjective in nature or which are derived from authority—for example, the relative importance of a painting in a particular artist's oeuvre. The instantiation method therefore includes a process for extending the original object specification with supplements in which attributes of the virtual object that were overlooked unaccounted for, or which have mutated are (re-)defined. This may be particularly useful for objects with an ongoing history (either real or fictional) at the time of their instantiation.

Various types of objects may be embodied by the virtual object specification. Most straightforwardly, the specification may identify an existing real-world physical object either unitary in structure, composite in structure, or an aggregation of independent sub-objects. A specification may also identify a no-longer extant object, either because the object has been lost or destroyed (e.g. James Dean's Porsche 550 Spyder), or because the object is conjectural/hypothetical, and cannot definitively be proven to have or have not existed. In addition, the object may not be a real-world one, and exist only in fiction (e.g. Sherlock Holmes' pipe) or myth/legend (e.g. Excalibur). More abstractly, the object may be conceptual, having either no physical embodiment (e.g. “Winston Churchill's eloquence”, “the creativity of Silicon Valley”), or be an abstraction which transcends any particular embodiment (“the formula for Coca-Cola”, “the Declaration of Independence”). Each sort of object will have different modeling exigencies when the specification for it is defined. As mentioned above, it is particularly important to define those characteristics that cannot be objectively determined from the object's identity.

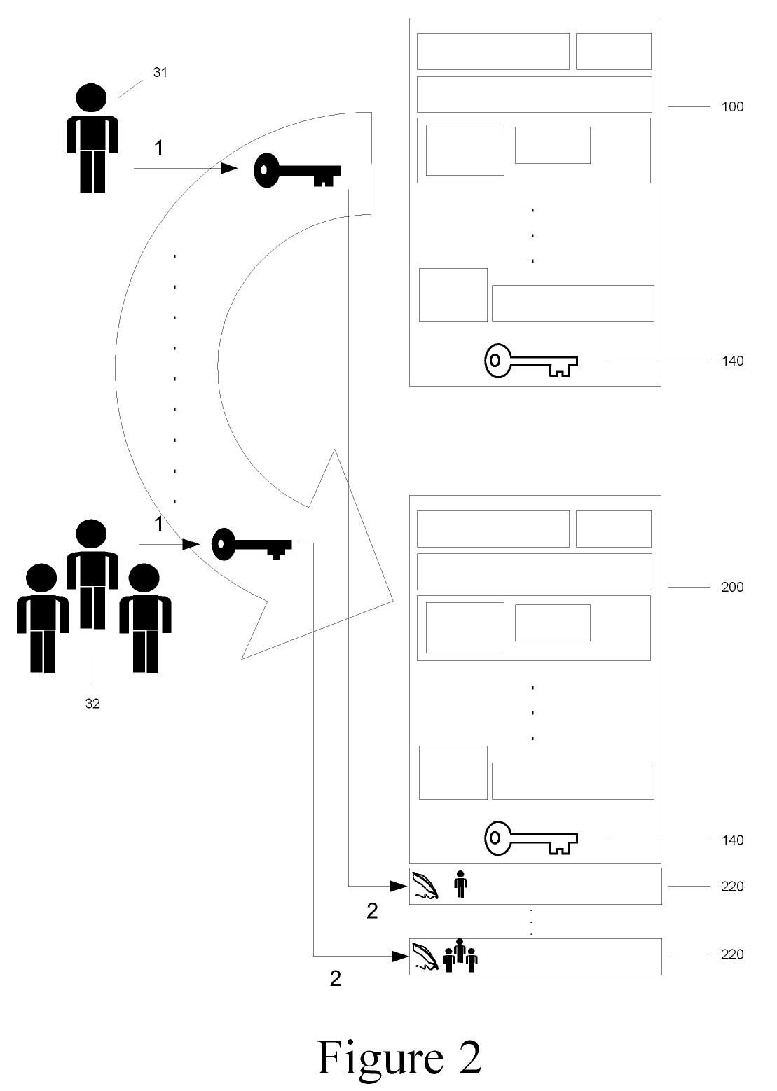

FIG. 2 illustrates the object instantiation method. Once the object specification 100 is defined, a computer-readable ownership document is created by appending the identification credentials of the initial owner 140 to the specification. Instantiation happens when the ownership document is authenticated (Action 1) by one or more of that object's claim-holders, a claim-holder being defined herein as a party (either individual 31 or corporate 32) with substantial, socially-recognized claim to the object's disposition. Various types of claims are possible, and will vary depending on the object class and type. Obviously there must be no legal encumbrances upon the object (e.g. trademark, copyright) that would affect the creation and exchange of its virtual representation. The primary criterion for choosing claim-holders is to create social consensus for the identity of the virtual object. A claim may consist of current ownership or physical possession of the real world object. A claim may also consist of intellectual or artistic contributions to the design, invention, refinement, creation, authorship, crafting, aesthetic realization, enhancement, enactment, execution or popularization of the object. Examples of such claim holders include authors, film directors, actors, and athletes; these examples should in no way be considered exhaustive, however. Claims may also be administrative or logistical in nature, the party having facilitated, distributed, or otherwise organized for the object—for example, Major League Baseball in relation to any instance of professional baseball memorabilia. Another type of claim proceeds from cultural authority, for example—the national library or museum of a country for objects from that country's history or body of legend. Many other sorts of claims are possible, and these examples should in no way be considered exhaustive. Again, the imperative is to create social consensus for the identity of the object and to preclude the creation of a contending virtual object by claim-holders not included in the process. As such it is theoretically desirable to include the totality of claim-holders in the instantiation process, though in practice this will usually be limited to only the most significant by various practical limitations (e.g. remuneration).

Authentication of the object ownership document by the object claim-holders (Action 1) may take place in parallel for each claim-holder. Each resultant authentication certificate 220 is then appended (Action 2) to the object ownership document 200, completing the process.

Extension of the object with supplementary object specification documents to account for overlooked, changed, or completely new attributes follows the same flow as for instantiation. The object claim-holders 31 and 32 authenticate a supplementary object specification, and the resultant authentication certificates 220 are associated with the object ownership document 200. Extension of an object specification may occur repeatedly. To make the extension process more efficient, the object claim-holders may choose to invest a single party with authority to extend the object. This is done by each of them separately authenticating the delegated party's identity and role, and has a flow similar to the object instantiation process. In fact, an original object specification document may contain a field designating the identity of the party with authority to issue supplements, in which case object instantiation and delegation of object extension authority occur together. The delegated party extends the object by authenticating supplementary object specifications.

In the preferred embodiment of the invention, the identity credential of the initial owner is their public-key certificate, authenticated within a socially-recognized public-key infrastructure (PKI); the claim-holder mechanism of authentication is digital signature using the private-key counterpart of a public-key certificate also from a socially-recognized public-key infrastructure; and the resultant virtual object encoded in a cryptographic message format (e.g. PKCS #7, S/MIME, etc). Those skilled in the art will be familiar with the various algorithms and standards available to implement the method. Note that there is no requirement for a common public-key infrastructure between the initial owner's public-key certificate and the authenticating claim-holders', or between that of any two claim-holders. In practice, though, the number of socially-recognized public-key infrastructures and root certificate authorities is limited, and the various participants in the virtual object instantiation process will typically have user certificates from common PKI's.

Another possible embodiment of the instantiation process comprises claim-holders authenticating the object ownership document through generation of an authenticated signal on an electronic communications channel, such as through a service on a network-connected computer. Various sets of input and output parameters are possible for such a service: for example, one might accept encoded party and virtual object identifiers as inputs and return either an affirmation or denial of that party's status as original owner of the object as output, while another may take as input the encoded identity of a virtual object and return the encoded identity of the original owner as output. Those skilled in the art will recognize there are multiple means for implementing such a service (e.g. Web services) and that multiple functionally-equivalent input/output specifications (i.e. function signatures) for the service are possible as well. Those skilled in the art will also recognize that various mechanisms (e.g. Secure Sockets Layer, or SSL) exist for ensuring the integrity and authenticity of the authentication signal generated by the owner-proxy, even over insecure communication channels such as the Internet. A disadvantage, however, is that it depends upon the constant availability and accessibility of the network service, and hence introduces a greater potential for system failure. It also allows the repudiation of original ownership status by the cessation of authentication for a particular party.

### Object Transfer

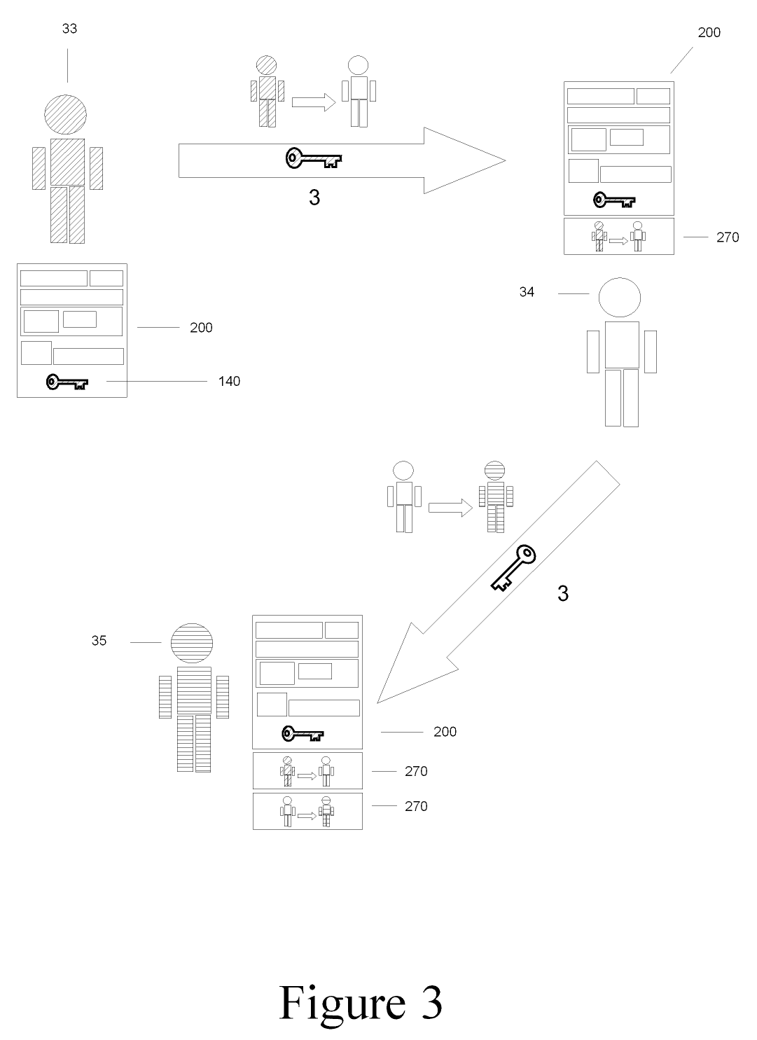

An object transfer method is illustrated in FIG. 3. The initial owner 33 is the party, either individual or corporate, to which the virtual object was assigned when the virtual object ownership document 200 was created as a result of the object instantiation process. The initial owner 33 may transfer the object to a new owner 34 by authenticating an object transfer document (Action 3). The resultant authenticated object transfer document 270 is kept by the new owner as proof of his acquisition of the object. Should the new owner 34 transfer the object to a subsequent owner 35, the process (Step 3) is repeated, with the only difference being that now there are multiple object transfer documents 270 kept by the succeeding owner 35 as proof of his acquisition. This chain of object transfer documents thus grows by 1 upon each transfer of the object.

The object transfer document must identify both the object being transferred and the new acquiring owner. Because no system of central or coordinated object instantiation is assumed by the invention, unique keys on the object specification are not sufficient to identify the object, as these cannot be guaranteed to be unique across all objects. Rather, the identity of the object is a function of both the object specification and the identities of the claim-holder(s) which instantiated it. For example, any virtual object specification may claim to be the “Mona Lisa”, but only one authenticated by the Louvre is likely to be THE “Mona Lisa” created by Leonardo da Vinci. Thus the designation of the object on the object transfer document must reference the instantiating claim-holders, and not just identifiers or keys on the object specification.

In addition to identifying the object and acquiring owner, the object transfer document may have various transaction data such as time of transfer, transfer sequence number, etc. These latter are particularly important to preclude attempts at ownership forgery. For example, circular transfer sequences are possible where owner A transfers an object to owner B, who then transfers the object back to owner A. In cases such as this it should not be possible for owner B to produce a valid transfer document chain by appending the authenticated transfer document of A-to-B after B-to-A. Those skilled in the art will recognize various attributes which can be included in a transfer document that would preclude such attacks. Another significant attribute within an object transfer document may be an expiration date marking the end of transfer effectively so that any transfer chain in which a transfer document has expired is invalid. This may be used to simulate object leasing, in which an object is transferred to a new owner for only a limited time. To make such limited ownership rights explicit, a non-transferability flag attribute may be used within the transfer document.

In a preferred embodiment of the invention, authentication of an object transfer document occurs through digital signature of a document containing the acquiring party's public key certificate from a socially-recognized PKI. Those skilled in the art will recognize the various digital authentication algorithms which may be used to authenticate the object transfer document, as well as those formats suitable to encoding the authenticated transfer document. Those skilled in the art will also recognize efficient methods of specifying the object's identity through object and claim-holder certificate serial numbers or keys, or through hash functions applied to the object ownership document.

Object transfer will typically be the culmination of a larger transaction in which the object is exchanged, either for another virtual object, real-money payment, etc. The integration of this object transfer method into the larger transactional process is obvious to anyone skilled in the art, and as such the various common transactional scenarios (sale, exchange, wager, escrow, etc.) in which object transfer may be embedded are not described here.

### Object Presentation

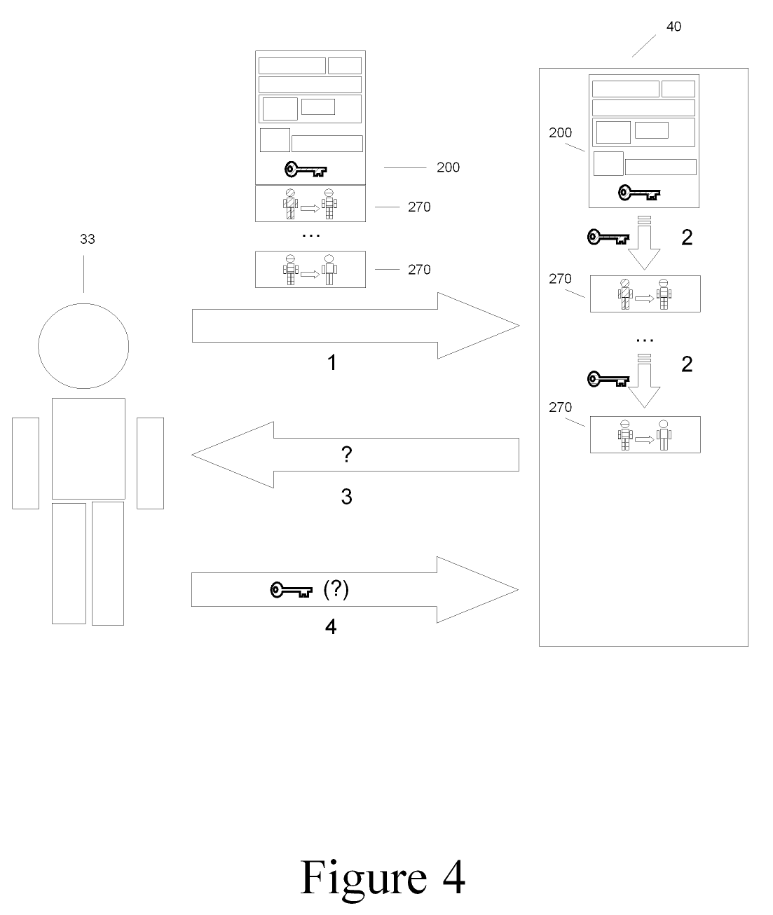

To obtain the benefit of a virtual object, the owner must first present it and prove he is its rightful owner, a process illustrated in FIG. 4. The owner 33 sends (Action 1) the object ownership document 200 to the system 40 wherein he wishes to claims its benefit, along with the current chain of object transfer documents 270, if any. The receiving system 40 first determines if it will recognize the object at all, based upon the object's own identity or the broad class of items to which it belongs. If the item itself is acceptable the system 40 determines the current owner by validating (Action 2) the chain of ownership transfer documents 270 sent to it. Beginning with the initial owner in the object ownership document 200, it verifies the authenticated object transfer document 270 using the initial owner's authentication credentials. If the object transfer document 270 is valid, it then repeats the process for the subsequent object transfer document 270, this time considering the acquiring owner from the previous object transfer as the object's current owner. This is repeated for all object transfer documents 270 in the chain. If a single transfer document fails validation the system 40 refuses to recognize the owner's claim to the object. If there are no validation failures, the system 40 sends a challenge to the owner 33 to authenticate his identity (Action 3) to which the owner must respond (Action 4). If the owner's challenge response validates, then the owner 33 has proven his identity to the system 40. Note that other validations may be possible depending upon what attributes are present on an object transfer document. If an object transfer document 270 has an expiration date, for example, the system 40 will check that it is subsequent to the current time; object transfer documents may also have sequence numbers, in which case validation will include a check to see that these numbers have the correct progression.

In the preferred embodiment of the invention, the owner proves his identity by using the private-key counterpart to the public-key certificate within the last object transfer document (or within the object ownership document itself if no transfer chain exists). Those skilled in the art will recognize that several cryptographically-secure public-private key challenge protocols are possible, generally divided between those where the owner signs challenge data and those where he decrypts challenge data.

Once object ownership is proven, the system may allow the user to claim the benefit of the object immediately, or else impose additional conditions before the user can benefit from the object's utility. For example, in some game systems proof of ownership may be sufficient to begin claiming benefit of the object. In others, such as massively multiplayer online role-playing games (MMORPGs) or other types of persistent virtual worlds, a precondition of use may typically include agreement to forfeit the object should the player “lose” the object within the game according to various game-specific conditions. In such cases the system may require the owner to transfer the object to itself in order to enforce forfeiture conditions, then transfer it back when the user exits the system should he still be in possession of the object according to the game's ownership rules. Transfer occurs according to the object transfer process previously described.

### Owner-Proxy Ownership System

Ownership within the property system allowed by this invention consists of either being the initial owner (specified at the time of the virtual object's instantiation), or else of being the last party to whom the object was transferred, where transfer occurs upon the authentication of a transfer document identifying the object and its new owner by the current owner. This is very similar to many real-world property transfer mechanisms, such as the transfer of a title of ownership by manual signature.

A problem with this system, inherent to most current mechanisms of digital authentication, is that all previous owners are still capable of claiming ownership of the object by presenting a truncated transfer document chain excising all object transfers since their own loss of possession. To the system to which the object is presented, the object ownership document and truncated transfer document chain will appear valid, and the non-current owner will be able to successfully respond to the system's challenge to identify himself. In effect, revocation is a positive property in most schemes of digital authentication, in that, in the absence of evidence, it is assumed not to have occurred. To ensure that previous owners do not claim objects that have ceased to be in their possession, proof of ownership revocation must be distributed to all systems accepting these objects. Though an analogous system—in the form of certificate revocation lists—is in fact used to revoke public-key certificates in a PKI, the much-higher rate of revocation in a property system (corresponding to the rate of object transfer) makes it impracticable here.

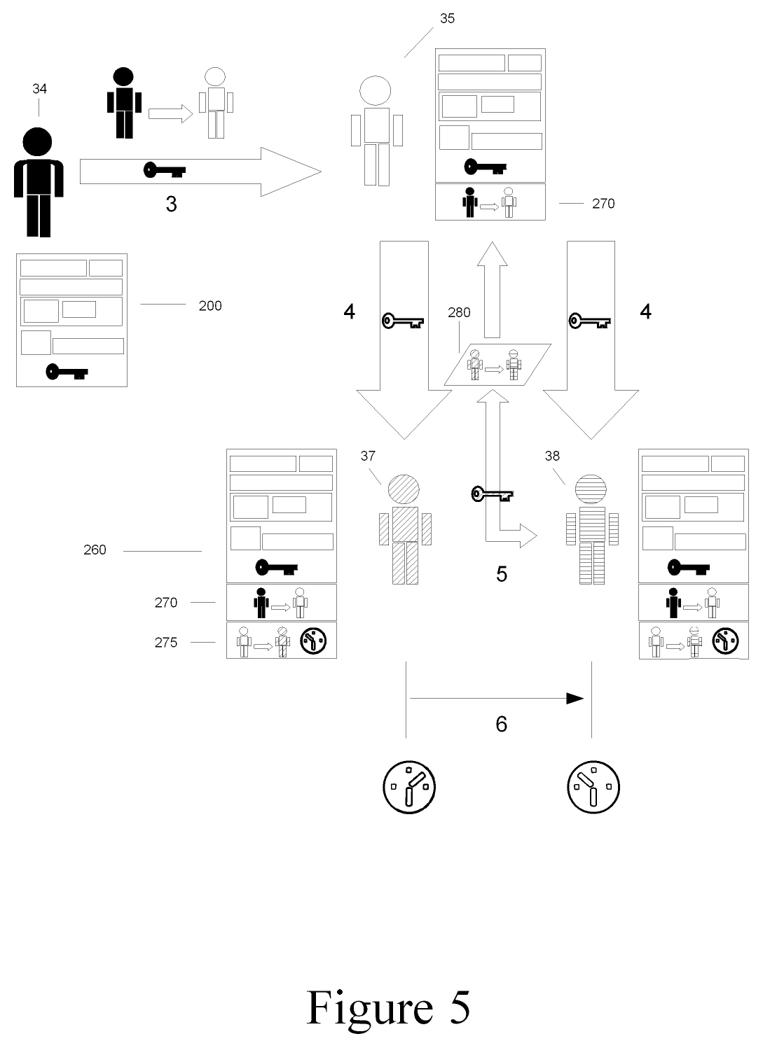

Instead, an owner-proxy system is used wherein owner-proxy entities keep objects in trust for their actual owners, and authenticate those owners' claims on a duration-limited basis. The system is illustrated in FIG. 5. The owner-proxy 35 comes into nominal ownership of the object, either by being the party specified as the initial owner in the object ownership document 200 during the object's instantiation, or else by receiving the object through authentication (Action 3) of an object transfer document 270 by the object's current owner 34. The owner-proxy 35 keeps record of the object's actual owner 37, and authenticates upon request (Action 4) a duration-limited object claim authenticator 275 for the actual owner 37 so that the actual owner may present the object to various systems for use, as described previously.

A “direct” owner-proxy system is also possible, in which each of the object claim-holders effectively acts as an owner-proxy by maintaining current ownership associations for the object and establishing upon request the identity of the current owner by authenticating a duration-limited ownership claim authenticator. A “direct” owner-proxy system does not represent a preferred embodiment of the invention because it would impose additional burdens upon claim-holders, who would be required to arbitrate object transfers as well as synchronize with one another if a plurality of claim-holders exist for a single object, it is technically viable given the ubiquity of globally inter-networked (i.e. Internet-connected) computer systems. In addition, if there is only a single claim-holder for the object or delegating the role of owner-proxy to a separate party is undesirable, a direct owner-proxy system may be deemed preferable.

In the preferred embodiment of the invention the authenticator is a duration-limited, digitally signed ownership transfer document from owner-proxy to actual owner. Ownership verification by the receiving system occurs exactly as described before, except that as part of validation the system will check the expiration date of the last object transfer document to make sure it is still current.

An alternative to traditional public key infrastructure digital signature mechanisms for authenticator-generation is provided by identity-based encryption (IBE) schemes, the first practical embodiments of which were recently disclosed by Boneh and Franklin. The chief advantage of such schemes is that any string may be used as a valid public key, and so with suitable conventions in place the current public key of every principal is known to all, obviating the need for a mechanism of timely public key distribution. Within the context of the present invention this means that the receiving system for a virtual object does not need to extract the current owner public key from a chain of object transfer/claim documents presented to it in order to issue an identity challenge; rather, it can deterministically compute it based solely upon the object identifier. In effect, the owner public key for any object is some encoding of the string “the owner of object <OID> at date <TIME>”, where <OID> is a unique identifier for the object and <TIME> is the current date to some arbitrary precision (e.g. year, year-month-day, year-month-day-hour-minute-second, etc.) Those with skill in the art will recognize that multiple encoding schemes are possible for the public key identity. In the IBE embodiment of the invention the owner-proxy assumes the role of private key generator for the entire scheme, and must at some point upon taking custody of the object authenticate the “public key” of the entire IBE scheme (typically its setup parameters)—either by having it authenticated directly by the previous owner/initial claim-holders as part of the object transfer/object instantiation processes, respectively, or else by themselves authenticating the scheme public key with their new-owner identity credential authenticated during those same processes. When an actual owner requires an authenticator for his status as owner of a particular object, the owner-proxy extracts the private key for the current owner identity string for that object and delivers it to him. Should custodianship be transferred to a new owner-proxy, the retiring owner-proxy may either give the new owner-proxy the system private key for the entire IBE scheme, or else simply authenticate an object transfer to the new owner-proxy as before, including authenticating the public key of a new identity-based encryption scheme. Note that it is possible for a plurality of objects to be managed within a single IBE scheme.

Other forms of owner claim authentication by the owner-proxy are possible as well, such as through the operation of a networked service which is visited whenever the ownership verification process occurs. Various sets of input and output parameters are possible for such a service: for example, one might accept encoded party and virtual object identities as inputs and return either an affirmation or denial of that party's current ownership of the object as output, while another may take as input the encoded identity of a virtual object and return the encoded identity of the current owner as output. Those skilled in the art will recognize there are multiple means for implementing such a service (e.g. Web services) and that multiple functionally-equivalent input/output specifications (i.e. function signatures) for the service are possible as well. Those skilled in the art will also recognize that various mechanisms (e.g. Secure Sockets Layer, or SSL) exist for ensuring the integrity and authenticity of the authentication signal generated by the owner-proxy, even over insecure communication channels such as the Internet. A networked owner-proxy authentication service is not part of the preferred embodiment, however, because it depends upon the constant availability and accessibility of the network service, and hence introduces a greater potential for system failure.

In the preferred embodiment the actual-owner must thus continually receive new object claim documents to replace old ones as they expire, though this process can be automated by a software module, either stand-alone or embedded. Object claim documents may also be issued automatically on a predetermined schedule to the actual-owner, and pushed from the owner-proxy system to the computing environment of the actual owner. Those skilled in the art will recognize various schemes of more conveniently circulating claim documents between owner-proxy and actual owner.

The actual-owner 37 transfers the object to another party 38 by authenticating and presenting (Action 5) a transfer signal 280 to the owner-proxy. There are several mechanisms for the actual-owner to do this, including authenticating a message through digital signature, or logging into a system trusted by the owner-proxy (which may not necessarily be controlled by the owner-proxy) and taking action to deliver a transfer-request signal/message to the owner-proxy through it—for example, by filling in and submitting a form. The owner-proxy 35 then validates the transfer request message by verifying that it indeed was sent by the actual-owner, and then checking if any pending transfer requests for that object exist. If there are none, then the transfer succeeds; if there is already an outstanding transfer request then the transfer fails. Those skilled in the art will recognize mechanisms of serializing transfer requests so that even in the case of multiple concurrent transfer requests, at most one is ever approved. Upon passage of sufficient time (Flow 6) for the expiration of the last enduring object claim authenticator issued on behalf of the actual owner 37, the owner-proxy transfers actual ownership of the object to the new owner party 38, and begins issuing (Action 4) duration-limited object claim authenticators on its behalf.

A particular property of this system is that a new owner cannot begin using an object until after the last-enduring object claim authenticator ever issued by the owner-proxy expires. This is done to preclude simultaneous use of the object by both the newest owner and his predecessor(s) in the absence of any system of revocation notification, as discussed previously. Because of this limitation, a owner-proxy must in practice enforce reasonable limits on the forward-effectivity of the object claim authenticators it authenticates for actual-owners, so that an object is not inadvertently bound to a particular owner for an unreasonably long period of time—for example, 50 years. The temporal endurance of a particular object claim authenticator, however, does not necessarily preclude immediate trade in the object, much as various financial instruments such as options and futures are traded before the underlying financial instrument is actually exercisable.

In this system an owner-proxy is a trusted entity for the actual owner and may inherit this relationship with a new actual owner—i.e. by becoming their owner-proxy for that object upon the change of possession. This in effect makes the owner-proxy a trusted entity for both parties in any object transaction; as such, it is possible for the owner-proxy to take on additional functions during the transfer, such as escrow. Object transfer within an owner-proxy system will typically be the culmination of a larger transaction in which notifying the owner-proxy of a change in actual ownership is a sub-flow embedded within a greater flow involving object discovery, transfer terms negotiation, escrow verification, etc. Those skilled in the art will know how to integrate object transfer by an owner-proxy system into such larger flows.

Owner-proxies may transfer objects between themselves, either on a permanent or duration-limited basis. This is done using the same process as for other object transfers. Transfer between owner-proxies may occur at the behest of the actual owner—for example, concomitant with object transfer between actual owners so that the new owner can have the object managed by the owner-proxy he has a pre-existing relationship with. Objects may also be transferred from owner-proxies should a particular proxy cease operation; though optimally this should be to another owner-proxy system, the owner-proxy may always release the object to the actual owner, this time by authenticating a non-expiring object transfer document.

In this system minimal coordination is required between the various principals. The owner-proxy is trusted to authenticate duration-limited object claim authenticators only for an object's current actual owner, and to cease authentication activity for that party once the object is transferred to a new actual owner party, or for the object entirely if it is transferred to a new owner-proxy system. Thus once the object leaves the owner-proxy's custody its duties become wholly negative—not to perform certain actions—and so the object is not limited in any way should the proxy cease operation: it still will have global persistence.

An owner-proxy system has several additional advantages besides efficiently preventing claim of an object by past owners. 1) Because the actual owner does not have the ability to unilaterally transfer the object (only the owner-proxy can authenticate duration-unlimited object transfer documents), any compromise of the actual owner's computing system will not have permanent consequences, an important concern given that the typical actual owner's computing environment (a personal computer or a mobile computing device) will be much less secure than the owner-proxy's. 2) No matter how many changes in actual ownership occur for a particular object, the object transfer document chain will not grow provided the object stays with the same owner-proxy; thus an owner-proxy system can prevent an object transfer document chain for a particular object from becoming unwieldy as it is continually exchanged. 3) Transfer is always reversible within a particular owner-proxy system, and so the legitimate actual owner can regain his property should a transfer later be proven to have been fraudulent, illegal, the result of user or system error, etc.

Systems to which the object is presented need not have interaction with the owner-proxy or object instantiator, as all information required by them is present “in-line” in the object ownership document (which contains the object specification) and the chain of object transfer/claim documents, if any, proving ownership. The identity of an object, as previously discussed, is a function of both the object specification and the identities of the claim-holder(s) which instantiated it. Those skilled in the art will recognize several methods to enhance performance when doing object identification—for example, through the use of indexes on object specification and claim-holder identity certificate serial numbers or other key values, or hash-functions applied to the entire object ownership document. In addition, the inherent hierarchy among claim-holders can be used to optimize the object identification process; an object authenticated by, say, Major League Baseball could always be assumed an instance of professional baseball memorabilia, and so a system accepting this class of object could in most cases look for this claim-holder in the object ownership document to the exclusion of all others. Combined with standard interfaces for broad classes of objects, a system could thus identify and interact with an unlimited number of globally-significant objects without maintaining a database of them all.

### Concomitant Object Transfer

In some implementations, transfer of the virtual object may be concomitant with the transfer of its real-world counterpart. Upon acquiring the object the new owner will thus attain the ability to present it to receiving systems and claim its benefit. Concomitant object transfer may also be used to facilitate real-world object exchange: because the real-world and virtual instantiations of the object are always transferred together, proving possession of the virtual instance (using the object presentation method described previously) also proves possession of the real-world instance. This fact can be leveraged in such venues as online markets to give the acquirer increased confidence that the (real-world) object they are purchasing is genuine.

Although the present invention has been described in considerable detail with reference to certain preferred versions thereof, other versions are possible. Therefore the spirit and scope of the appended claims should not be limited to the preferred versions herein.

I claim:

1. A method of virtual instantiation of a globally-significant object comprising the steps of:
creating a machine-readable virtual object specification comprising at least one object chosen from the group consisting of text fields, structured data fields, multimedia content fields, digital data fields, said at least one object sufficient to unambiguously identity the globally-significant object represented;
creating a computer-readable ownership document comprised of the virtual object specification and the identity of the party that is the virtual object's initial owner;
authenticating the machine-readable ownership document by at least one claim holder having a claim to the object;
associating each claim-holder authentication with the machine-readable ownership document.

2. The method of claim 1 wherein a party's claim to the object is comprised of either legal ownership or physical possession of the globally-significant object.

3. The method of claim 1 wherein a party's claim to the object is artistic or intellectual in nature, and is chosen from the group consisting of contributions to the design, development, invention, authorship, crafting, aesthetic realization, execution, enactment, popularization, or enhancement of the object.

4. The method of claim 1 wherein a party's claim to the object is either administrative or logistical in nature.

5. The method of claim 1 wherein language-specific fields of the virtual object specification are repeated for at least one translation into alternate human languages.

6. The method of claim 1 wherein authentication occurs through applying a digital signature to the ownership document using cryptographic keys, producing a machine-readable signature certificate.

7. The method of claim 6 wherein cryptographic keys are used to digitally sign the ownership document and the cryptographic keys are managed within a public key infrastructure.

8. The method of claim 1 wherein authentication occurs through manual signature.

9. The method of claim 1 wherein authentication involves a manual device-assisted signature.

10. The method of claim 9 wherein the manual device is a stamp or signet ring.

11. The method of claim 1 wherein authentication involves receiving an electronic signal from the claim-holder.

12. The method of claim 11 wherein the electronic signal is received over a secured communication channel.

13. The method of claim 11 wherein the electronic signal is generated by an access point on a network-connected machine.

14. The method of claim 13 wherein the access point is a service on a computer server.

15. The method of claim 1 wherein the ownership document contains a field indicating the document's expiration date.

16. The method of claim 1 wherein the virtual object represents a particular physical object, which is either homogeneous or heterogeneous in structure, and is either unitary or aggregate in composition.

17. The method of claim 1 where the globally-significant object comprises an object chosen from the group consisting of fictional, legendary, and mythical objects.

18. The method of claim 1 wherein the globally-significant object comprises either a particular conjectural or a formerly extant object.

19. The method of claim 1 wherein the globally-significant object comprises a conceptual entity.

20. The method of claim 1 wherein instantiation of a virtual object is concomitant with acquisition of the object's real-world counterpart.

21. The method of claim 1 wherein instantiation of a virtual object is independent of ownership of its real-world counterpart.

22. The method of claim 1 wherein instantiation of a virtual object is embedded in a larger transaction or process.

24. The method of claim 1, further comprising the step of extending an original object specification comprising the steps of authenticating one or more supplementary object specification documents by the object claim-holders and associating these documents with the original ownership document.

25. The method of claim 24 wherein a party is delegated authority to extend object specifications by the steps comprising authenticating the party's identity and identifying the party's role by the object claim-holders.

26. A method of transferring ownership of an instantiated virtual object, said object having an ownership document, from a transferring owner to a new owner comprising the steps of:
the transferring owner generating an object transfer authenticator identifying a new party as the new owner; and
associating the object transfer authenticator with the ownership document.

27. The ownership transfer method of claim 26 wherein the object transfer authenticator comprises an authenticated, machine-readable document specifying the object, the identity of the new owner, and its role as new object owner.

28. The ownership document transfer method of claim 27 wherein document authentication occurs through applying a digital signature to the ownership transfer document using cryptographic keys, producing a machine-readable signature certificate.

29. The method of claim 28 wherein cryptographic keys are used to digitally sign the ownership transfer document and the cryptographic keys are managed within a public key infrastructure.

30. The method of claim 26 wherein authenticator generation occurs through receiving an electronic signal from the transferring owner.

31. The method of claim 30 wherein the signal is received over a secured communication channel.

32. The method of claim 30 wherein the signal is generated by an access point on a network-connected machine.

33. The method of claim 32 wherein the access point is a service on a computer server.

34. The ownership document transfer method of claim 27 wherein the machine-readable object transfer document contains at least one transactional data chosen from the group consisting of date of transfer, transfer sequence number, date of expiration, or object non-transferability flag.

35. The method of claim 26 wherein transfer of a virtual object is concomitant with transfer of the object's real-world counterpart.

36. The method of claim 26 wherein transfer of a virtual object is independent of transfer of its real-world counterpart.

37. The method of claim 26 wherein transfer of a virtual object is embedded in a larger transaction or process.

38. The method claim 26 wherein the object transfer authenticator is duration-limited.

39. An owner proxy method of transferring ownership of at least one virtual instantiated object having an ownership document comprising the steps of:
an owner-proxy party acquiring at least one virtual object, either during object instantiation of the at least one virtual object or through transfer from a previous owner party to the owner-proxy, the at least one virtual object having an object specification, and a complete authenticated object transfer chain of object transfers said transfer chain having an ultimate transferee, wherein the owner-proxy is identified as the ultimate transferee;
the owner-proxy associating the at least one virtual object with an actual owner party;
the owner-proxy generating a duration-limited object claim authenticator from the owner-proxy to the actual owner, which is the last issued claim authenticator;
the actual owner presenting the duration-limited object claim authenticator to a receiving entity from which the actual owner wishes to claim benefit of the object;
the receiving entity validating the object specification, the complete authenticated transfer chain of object transfers, the object claim authenticator, and the identity of the actual owner, wherein the actual owner must be the last owner according to the authenticated object transfer chain;
the actual owner party transferring the object to a new actual owner party by signaling the owner-proxy to the identity of the new actual owner;
the owner-proxy validating the object transfer signal by the owner-proxy, including authenticating the identity of the actual owner and verifying that no previous transfer requests are pending; and
the owner-proxy associating the object claim authenticator with the new actual owner party effective upon the expiration of the last issued claim authenticator.

40. The owner-proxy method of claim 39, wherein the at least one virtual object has at least one owner-proxy party, the at least one owner proxy party being an object claim-holder from the instantiation of the virtual object, and wherein the at least one owner proxy party individually generates the claim authenticator.

41. The owner-proxy method of claim 39 where the object claim authenticator is a machine-readable document authenticated by the owner-proxy specifying the object and the identity of the object's actual owner.

42. The owner-proxy method of claim 41 wherein a digital signature is used for document authentication.

43. The method of claim 39 wherein generation of the object claims authenticator occurs through receiving a signal from the owner-proxy.

44. The method of claim 43 wherein the signal is received over a secured communication channel.

44. The method of claim 44 wherein the signal is generated by an access point on a network-connected machine.

45. The method of claim 44 where the access point is a network service.

46. The owner-proxy method of claim 42 wherein keys used for digital signature are managed within a public key infrastructure.

47. The owner-proxy method of claim 39 wherein the object claim authenticator is a private-key counterpart to the current owner's identity encoded in an identity-based encryption scheme.

48. The owner-proxy method of claim 39 wherein authentication of the object transfer signal occurs through its receipt over a secure communication channel.

49. The owner-proxy method of claim 39 wherein the authentication of an object transfer signal occurs through digital signature of the object transfer signal by the current actual owner.

50. The owner-proxy method of claim 41 wherein the machine-readable object claim document contains at least one transactional data chosen from the group consisting of generation, sequence number, and object non-transferability flag.

51. The owner-proxy method of claim 39 wherein at least one object is transferred from a current owner-proxy to a new owner-proxy by the authentication by the current owner-proxy of object transfer from it to the new owner-proxy and the assumption of actual owner associations and actual owner authentication by the new owner-proxy.

52. The owner-proxy method of claim 51 wherein authentication of transfer from the current owner-proxy to the new owner-proxy is duration-limited.

53. The owner-proxy method of claim 39 wherein object transfer between actual owners is embedded in a larger transaction or process.

54. The owner-proxy method of claim 39 wherein transfer between actual owners is duration-limited.

55. The owner-proxy method of claim 39 wherein transfer of the virtual object between actual owners is concomitant with transfer of the object's real-world counterpart.

56. The owner-proxy method of claim 39 wherein transfer of the virtual object between actual owners is independent of the transfer of the object's real-world counterpart.

57. The owner-proxy method of claim 46 wherein the trusted communications channel is a system requiring user login.
